(19) United States
(12) Patent Application Publication
(10) Pub. No.: US 2002/0157214 A1
(43) Pub. Date: Oct. 31, 2002

(54) Ergonomic gripping handle

(76) Inventor: Jeffery R. Hadley, Colorado Springs, CO (US)

Correspondence Address: Glen F. Gallinger, 7420 Milner Dr., # 1000, Colorado Springs, CO, 80920, US

(21) Appl. No.: 09/842,424

(22) Filed: Apr. 27, 2001

(51) Int. Cl. B62B 1/00

(52) U.S. Cl. 16/430

(57) ABSTRACT

An ergonomic gripping handle and a method of producing an ergonomic handle which is particularly well suited for application with wooden cylindrical handles. The handle comprises an elongate rounded handle member having lateral finger indentations therealong, said finger indentations extending around and across a longitudinal side portion of the handle member; and, a pliable plastic sleeve sized to matingly slip over the handle member. When the indented handle member is covered by the sleeve, the handle may be gripped by the sleeve. A method of fabricating a handle adapted for gripping with a hand comprising the steps of forming lateral finger indentations in an elongate and rounded handle member; and, matingly sliding a soft pliable sleeve over the handle member. The handle member may be more comfortably and easily gripped by the soft sleeve. The soft sleeve may be replaced when worn.

### FIELD OF THE INVENTION

This invention relates to generally cylindrical handles used to hold tools, sports equipment, and motorized equipment. More particularly this invention relates to an ergonomic gripping handle and a method of producing an ergonomic handle which is particularly well suited for application with wooden cylindrical handles.

### BACKGROUND OF THE INVENTION

Many hand and motorized hand held tools as well as many pieces of sports equipment are held by a generally cylindrical handle. In many applications these handles are held with substantially all of an individual's strength. in other applications the handles are held with a substantial load for extended periods.

The invention was first developed for a wheel barrow handle. It was found that the invention improved the handles on post hole diggers, tampers, rakes, hoes, forks and shovels as well as concrete tools such as floats, edgers, and brooms.

It is contemplated that the method and apparatus would have application wherever a generally cylindrical handle is gripped. Such applications would include roto-tillers, mowers, chain saws, hammers, sports rackets, and ball bats.

### OBJECTS OF THE INVENTION

It is an object of this invention to disclose an apparatus and method for a hand grip on a generally cylindrical handle member. It is an object of this invention to disclose a more ergonomic and easily held generally cylindrical handle. It is yet a further object of this invention to disclose a soft and finger indented handle which can be fabricated from readily available materials. It is a final object of this invention to disclose a soft formed grip which can be readily replaced when it becomes worn.

One aspect of this invention provides for an ergonomic handle comprising: an elongate rounded handle member having lateral finger indentations therealong, said finger indentations extending around and across a longitudinal side portion of the handle member; and, a pliable plastic sleeve sized to matingly slip over the handle member. So that when the indented handle member is covered by the sleeve, the handle may be gripped by the sleeve.

A method of fabricating a handle adapted for gripping with a hand comprising the following steps: forming lateral finger indentations in an elongate and rounded handle member; and, matingly sliding a soft pliable sleeve over the handle member. The handle member may be gripped by the soft sleeve and the soft sleeve may be replaced when worn.

Various other objects, advantages and features of this invention will become apparent to those skilled in the art from the following description in conjunction with the accompanying drawings.

### FIGURES OF THE INVENTION

FIG. 1 is an exploded perspective view showing an ergonomic handle having a cylindrical handle member having lateral finger indentations separated from a matingly sized soft plastic sleeve.

FIG. 2 is a cross sectional view taken along line 2-2 on FIG. 1.

FIG. 3 is an assembled perspective view showing the soft plastic sleeve slipped over and assembled on the formed handle member shown in FIG. 1.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

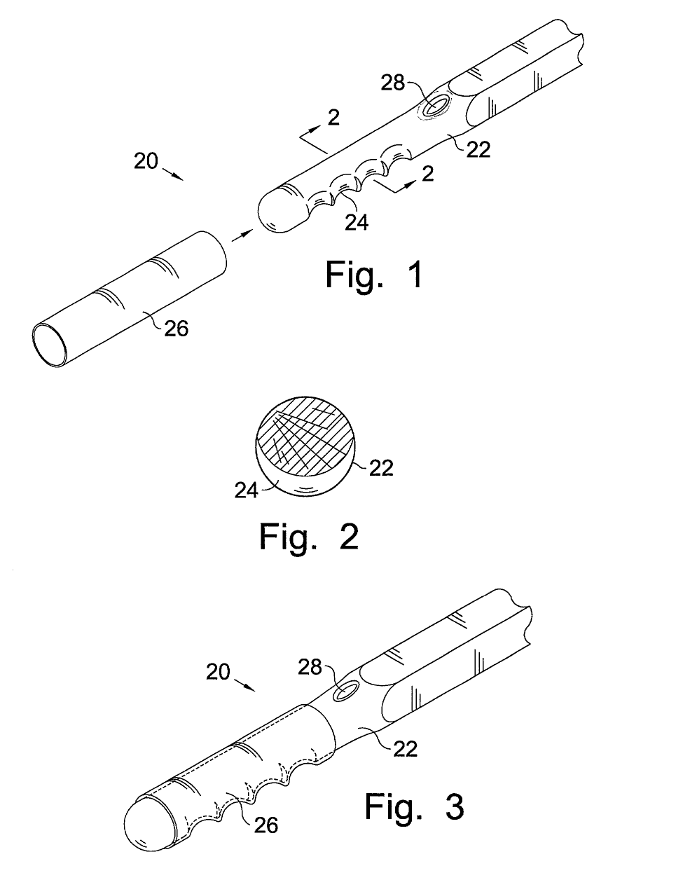

Turning now to the drawings and more particularly to FIG. 1 we have an exploded perspective view showing a handle 20 having a cylindrical handle member 22 having lateral finger indentations 26 separated from a matingly sized soft plastic sleeve 24. Most generally the handle member is elongate and rounded. The lateral finger indentations 26 extend around and across a longitudinal side portion of the handle member 22. The plastic sleeve 24 is pliable and sized to matingly slip over the handle member 22. When the indented handle member 22 is covered by the sleeve 24, the handle 20 may be gripped by the sleeve 24.

Most preferably the handle member 22 is generally cylindrical, and the sleeve 24 is a soft and compressible plastic. Alternatively the sleeve could comprise a gel such as silicone. In the most preferred embodiment of the invention the sleeve 24 is made of compressible foam plastic. The soft foam plastic sleeve 24 wears quickly; however, it may be readily and inexpensively replaced. There may be either three or four finger indentations 26 in the handle member 22. In the most preferred embodiment of the invention the handle member 22 is made from wood and the lateral finger indentations 26 are cut therein.

A method of fabricating a handle 20 comprises the following steps of forming lateral finger indentations 26 in an elongate and rounded handle member 22; and, matingly sliding a soft pliable sleeve over the handle member. Then the handle member 22 may be gripped by the soft sleeve 24 and the soft sleeve 34 may be readily replaced when worn.

While the invention has been described with preferred specific embodiments thereof, it will be understood that this description is intended to illustrate and not to limit the scope of the invention, which is defined by the following claims.

I claim:

1) An ergonomic handle comprising:
an elongate rounded handle member having lateral finger indentations therealong, said finger indentations extending around and across a longitudinal side portion of the handle member; and,
a pliable plastic sleeve sized to matingly slip over the handle member;
so that when the indented handle member is covered by the sleeve, the handle may be gripped by the sleeve.

2) A handle as in claim 1 wherein the handle member is generally cylindrical.

3) A handle as in claim 2 wherein the sleeve is a soft and compressible plastic.

4) A handle as in claim 2 wherein there are three finger indentations.

5) A handle as in claim 2 wherein there are four finger indentations.

6) A handle as in claim 3 wherein the sleeve is made of foam plastic.

7) A handle as in claim 3 wherein the sleeve comprises a gel.

8) A handle as in claim 6 wherein the handle member is made from wood and wherein the lateral finger indentations are cut therein.

9) A method of fabricating a handle adapted for gripping with a hand comprising the following steps:
forming lateral finger indentations in an elongate and rounded handle member; and,
matingly sliding a soft pliable sleeve over the handle member;
so that the handle member may be gripped by the soft sleeve and the soft sleeve may be replaced when worn.

10) A method as in claim 9 wherein the handle member is generally cylindrical.

11) A method as in claim 9 wherein the sleeve is a soft and compressible plastic.

12) A method as in claim 9 wherein there are three finger indentations.

13) A method as in claim 9 wherein there are four finger indentations.

14) A method as in claim 9 wherein the sleeve is made of foam plastic.

15) A method as in claim 14 wherein the handle member is made from wood and wherein the lateral finger indentations are cut therein.
